(19) United States
(12) Patent Application Publication
(10) Pub. No.: US 2022/0167646 A1
(43) Pub. Date: Jun. 2, 2022

(54) COOKING METHOD FOR OPERATING A COOKING DEVICE

(71) Applicant: V-Zug AG, Zug (CH)

(72) Inventors: Clemens Herlitzius, Schindellegi (CH); Marcel Lippmann, Steinen (CH); Jari Rudolph, Winterthur (CH); Marc Schönenberger, Zürich (CH)

(21) Appl. No.: 17/531,994

(22) Filed: Nov. 22, 2021

(30) Foreign Application Priority Data
Nov. 27, 2020 (EP) 20210385.9

(51) Int. Cl. A23L 5/10; A47J 27/04; A47J 36/32; F24C 15/32

(52) U.S. Cl. CPC A23L 5/13; A47J 27/04; A47J 36/32; A23V 2002/00; F24C 15/327; A47J 2027/043; A47J 2202/00; A23L 5/15

(57) ABSTRACT

A cooking method is used to prepare a food in the cooking chamber of a cooking device. The cooking chamber includes a first opening, a second opening and a closure for closing the second opening. Furthermore, the cooking device includes a temperature sensor arranged outside the cooking chamber for detecting gas volumes escaping from the cooking chamber through the first opening. During the cooking process, the closure is moved from a first position to a second position. After leaving the first position, a measurement is performed by means of the temperature sensor.

### CROSS-REFERENCE TO RELATED APPLICATION

This application claims foreign priority benefits under 35 U.S.C. § 119 to European Patent Application No. 20210385.9 filed on Nov. 27, 2020, the content of which is hereby incorporated by reference in its entirety.

### TECHNICAL FIELD

The invention relates to a cooking method for cooking food in the cooking chamber of a cooking device. The cooking chamber comprises a first opening and a second opening. A closure can be used to close the second opening. Furthermore, the cooking device comprises a temperature sensor arranged outside the cooking chamber. The temperature sensor is adapted to detect gas volume leaving the cooking chamber through the first opening.

### BACKGROUND

EP 2 279 682 discloses a cooking device which has a steam escape sensor, with which the escape of steam from the food can be detected. The steam escape sensor comprises an opening on the cooking chamber and a temperature sensor arranged outside the opening. If steam escapes from the food, hot gas escapes through the opening, which can be measured by the temperature sensor. In EP 1 619 443, the temperature sensor is used to open a flap when steam escapes from the food, which allows moisture to be removed from the cooking chamber.

### SUMMARY

The problem to be solved is to provide a cooking method comprising a precise measurement of a cooking parameter during the cooking method.

The problem is solved by the subject of the independent claim.

Accordingly, a cooking method is used to prepare food in the cooking chamber of a cooking device. The cooking chamber comprises a first opening, a second opening and a closure for closing the second opening. In particular, the two openings are arranged on one or more inner walls, i.e. side walls, ceiling and/or floor, of the cooking chamber. In particular, the two openings are not openings through which the user can insert the food into the cooking chamber. In particular, the closure is not the user door for opening and closing the cooking chamber.

The closure may comprise a flap that can be flapped or moved to a greater or lesser extent over the second opening by a stepper motor or servo motor. The closure can thus be continuously transferred from a closed to an open position. It would also be conceivable to have an embodiment in which the closure can only stay in a closed position or an open position.

The cooking device comprises a temperature sensor arranged outside the cooking chamber. This is used to detect gas volumes escaping from the cooking chamber through the first opening.

During the cooking method, in a first step, the closure is moved from a first position to a second position.

The movement is in particular a closing movement in closing direction. I.e. in the second position the second opening is less open than in the first position. The cross-section of the second opening is reduced due to the closing movement. Preferably, the second opening is completely closed by the closure in the second position.

After leaving the first position, in particular after reaching the second position, a measurement is performed by the temperature sensor. “After leaving” or “after reaching” refers to a temporal sequence. That is, the measurement can be performed, for example, immediately after leaving the first position or after a predetermined period of time since leaving the first position. For example, measurements can also be taken within a predetermined period of time since leaving the first position. For example, within five minutes since leaving the first position, it could be measured whether a temperature increase occurs. “After reaching the second position” also means “after leaving the first position”.

In particular, the measurement is carried out within a certain period of time since leaving the first position, in particular within 10 minutes, in particular within 5 minutes, in particular within 2 minutes, in particular within 1 minute.

The sequence of process steps, first closing the closure at least partially and then measuring, has the advantage that the measurement can be carried out within a controllable cooking chamber climate. I.e. by closing the second opening, gas escaping from the food leads to an excess gas volume in the cooking chamber, which is accompanied by an overpressure in the cooking chamber. If the second opening is closed, the excess gas volume escapes only through the first opening, so that the escape of gas from the cooking chamber can be measured as precisely as possible at the first temperature sensor.

In particular, after the measurement has been performed, the closure can be moved back from the second position to the first position. In particular, this is an opening movement.

The sequence of closing, measuring and opening has the advantage that a controlled cooking chamber climate is briefly created for the measurement, but the cooking process is only influenced as little as possible by the measurement.

Advantageously, the temperature sensor is used to measure the volume flow through the first opening. This is possible because the temperature inside the cooking chamber is higher than the temperature outside the cooking chamber. A temperature rise at the temperature sensor outside the cooking chamber can therefore be assigned to an overpressure in the cooking chamber.

The gas volume flowing through the first opening allows conclusions to be drawn about the evaporation rate of the food being cooked. In other words, the extent to which gas is released from the food being cooked is measured. In particular, gas escapes from the food to be cooked when the temperature of the food to be cooked exceeds 90° C. The temperature of the food to be cooked is measured.

Advantageously, the slope (dT/dt), in particular the maximum slope (dT/dt max), of a temperature rise, in particular over a certain time period, is measured at the temperature sensor.

A slope of a temperature rise (dT/dt) determined after closing the closure, in particular a certain maximum slope of a temperature rise (dT/dt max), is dependent on the volume flow flowing through the first opening and the cooking chamber temperature. Furthermore, the volume flow rate flowing through the first opening is dependent on the evaporation rate of the food being cooked. I.e., by determining the slope of the temperature rise, the evaporation rate of the food can be determined.

The measurement of the volume flow by means of the temperature sensor is also possible in particular due to the thermal inertia of the temperature sensor. The more “hot” air flows past the temperature sensor, the faster the temperature sensor takes on the temperature of the air flow. Therefore, there is a relation between volume flow and the slope of the temperature rise (dT/dt).

If, for example, the temperature sensor does not detect a temperature rise after the closure is closed and the cooking chamber temperature remains constant, the food is not releasing any gas into the cooking chamber. If the closure is opened again after the measurement, it can be assumed that a dry atmosphere prevails in the cooking chamber as long as the second opening remains open.

In a particular embodiment, the time between leaving the first position or reaching the second position until the temperature sensor detects a change, in particular a temperature increase, in particular a temperature increase from a predetermined value, is measured.

When the closure of the second opening is closed, the gas emitted by the food no longer flows through the second opening, but through the first opening. However, the temperature sensor detects the volume flow only with a time delay after the gas has left the first position of the closure. This time delay represents a measure of the volume flow. The higher the volume flow, the faster the temperature sensor will detect the volume flow.

Advantageously, the measurement of the temperature sensor is used to determine an absolute temperature change during a predetermined time period after leaving the first position. This measured value also represents a measure of the volume flow passing through the first opening. This is because the higher the volume flow, the faster the temperature sensor will measure a changed temperature due to its inertia.

Advantageously, the humidity inside the cooking chamber can be determined by the measurement of the temperature sensor.

The more gas is emitted from the food, the more humid is the atmosphere in the cooking chamber. The level of humidity correlates with the size of the volume flow and in particular with the position of the closure. The correlation between volume flow and air humidity can be determined by calibration measurements. The humidity in the cooking chamber also depends on the position of the closure and the cooking chamber temperature. Calibration measurements must therefore also be carried out as a function of the closure position and the cooking chamber temperature.

Determining the humidity inside the cooking chamber makes it possible, for example, to display this to the user. If the humidity inside the cooking chamber is too high or too low, the user can influence the atmosphere in the cooking chamber by known measures, for example by activating or deactivating a steam generator or by changing the position of the closure.

Advantageously, the measurement made by the temperature sensor can be used to control the cooking process. Depending on the measurement, for example
a position of the closure can be set, and/or
the cooking chamber temperature can be set, and/or
the cooking method can be terminated, and/or
the operating power of a device fan can be set, and/or
steam generator can operated, and/or
a new program phase can be initiated.

Advantageously, the inventive cooking method is carried out in a dry climate. A dry climate exists, for example, in a hot-air oven or a microwave with sufficient fresh air supply. In these cooking methods, no steam is introduced into the cooking chamber by means of a steam generator in order to cook the food in an artificially induced steam atmosphere.

### BRIEF DESCRIPTION OF THE DRAWINGS

Further embodiments, advantages and applications of the invention result from the dependent claims and from the following description on the basis of the figures. The figures show:

FIG. 1 a schematic section through a cooking device;

FIG. 2 a temperature curve at the temperature sensor; and

FIG. 3 a correlation between maximum temperature slopes and humidity in the cooking chamber at a certain cooking chamber temperature kept constant.

### DETAILED DESCRIPTION

The cooking device shown in FIG. 1, which is in particular a baking oven, has a cooking chamber 1 which is limited by inner walls 2 and a user door 3. The device shown as an example can be operated both as a baking oven and as a steam cooking device. It has a conventional resistive heater with top heat 5a and bottom heat 5b (which may be located inside the cooking chamber 1, as shown, but may also be located outside the cooking chamber 1). The heater 5a, 5b is used to heat the gases located in the cooking chamber. Alternatively or in addition to the heater 5a, 5b, the device can also be equipped with hot air, with a grill heater or with a steam generator.

Outside the cooking chamber 1, a cross-flow fan 5 is arranged as a blower. Depending on the required design, other types of fans, such as radial fans, can also be used. The fan conveys air from an intake area 6 into a pressure chamber 7. From the pressure chamber 7, the conveyed air exits into the environment through an outlet opening 8 at the front of the unit. The pressure chamber 7 is bounded at the top by an inclined top plate 9 and at the bottom by an inclined bottom plate 10, in such a way that the pressure chamber 7 tapers towards the outlet opening 8. Laterally, the pressure chamber is closed by side walls (not shown). The design of the pressure chamber 7 tapering towards the outlet opening 8 is not absolutely necessary. It is also conceivable that the top plate 9 and the bottom plate 10 are substantially parallel.

A first opening 12 and a second opening 16 are arranged in the ceiling of the cooking chamber 1. Opening 16 has a diameter of about 2.5 cm, opening 12 is preferably smaller.

Furthermore, the device has a temperature sensor 13, which is arranged in a protective housing 14. The temperature sensor measures a temperature Tx. The first opening 12 is always open. The protective housing 14 is arranged in the pressure chamber 7 and communicates with it via a connection opening 15. The connection opening 15 is located on the side of the protective housing 14 facing away from the blower.

A second, closable opening 16 connects the cooking chamber 1 with the intake area 6 in front of the blower 5. For closing the second opening 16, a closure 17 is provided which consists of a flap 18 which can be pushed to a greater or lesser extent over the mouth of the second opening 16 by a stepper motor or servomotor 19 in such a way that the closure can be transferred substantially continuously from a closed to an open position. It is also conceivable to have an embodiment in which the closure 18 can only assume a closed position and an open position.

A controller 20 is provided for controlling the closure 17 and the other components of the cooking device, which, among other things, monitors the temperature signal emitted by the temperature sensor 13.

A cooking chamber temperature sensor 21 is further provided in the cooking chamber 1, which can be used to measure the temperature of the cooking chamber. Further, a core temperature probe may also be provided (not shown), for example in the form of a needle which can be inserted into the food to be cooked. However, in the methods described below, this core temperature probe is not necessarily used.

In the operation of the cooking device, the blower 5 is continuously in operation. However, its output can be adjusted as required. It sucks in air from the environment through openings in the rear wall and side walls of the cooking unit. This air passes through the intake area 6, is blown into the pressure chamber 7 and leaves it through the outlet opening 8. Since the pressure chamber 7 is tapered towards the outlet opening 8, this creates a slight overpressure in the pressure chamber 7, i.e. a pressure that is higher than the ambient pressure, while the pressure in the intake area 6 is lower. Thus, a certain overpressure must prevail in the cooking chamber 1 in order for the temperature sensor 13 to detect a temperature rise caused by escaping gas volume from the cooking chamber. On the other hand, steam can be quickly and efficiently extracted from the cooking chamber 1 by opening the opening 16.

Furthermore, the function of the fan 5 is to discharge the air that has heated up on the outside of the cooking chamber to the outside in order to cool the device.

The device shown here can be operated in various operating modes, for which purpose the control 20 is provided with suitable input elements by means of which the user can select a desired program. In particular, the device can be operated in a conventional manner as a cooking device, for example by setting a desired cooking chamber temperature.

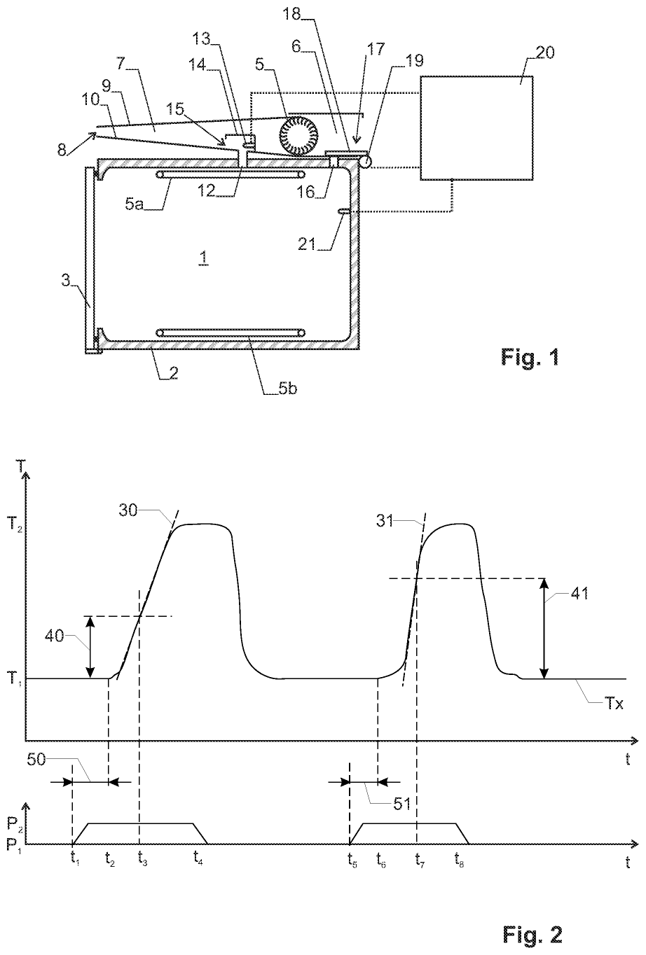

FIG. 2 will now be used to explain how the temperature sensor 13 works. The initial situation is a cooking process in which the food is cooked in the cooking chamber using hot air. This is, for example, a circulating air operation or a top heat/bottom heat operation, as is known from conventional ovens.

During hot air operation, the second opening 16 is basically open. The flap 18 does not cover the second opening 16.

If the temperature of the food to be cooked rises to over 90° C., for example, gas or steam escapes from the food to be cooked. This gas leaves the cooking chamber 1 via the second opening 16 because a lower pressure prevails in the intake area 6 compared to the pressure chamber 7. Thus, when the flap is open, hardly any or no air or steam flows out of the cooking chamber 1 through the first opening 12 to the temperature sensor 13. While the cooking chamber temperature sensor 21 measures the hot air temperature of the cooking chamber of, for example, 210° C., the temperature sensor 13 behind the first opening 12 detects a much lower temperature value of, for example, 40° C. because, as mentioned, hardly any or no hot air leaves the cooking chamber 1 through the first opening 12, but air can even enter the cooking chamber 1 through the first opening.

When the flap 18 is open, the temperature sensor 13 is therefore unsuitable for making a statement about the climate in the cooking chamber 1 or about the condition, for example the evaporation rate, of the food being cooked. If a measurement is to be made using the temperature sensor 13, the flap 18 must first be closed. That is, the flap 18 is moved from a first open position to a second closed position. Now hot air or steam can leave the cooking chamber essentially only through the first opening 12. The hot air or steam flows past the temperature sensor 13. The temperature sensor 13 detects a temperature increase.

Such a behaviour is shown in FIG. 2 by means of a diagram. The upper diagram shows the temperature curve of the measured temperature Tx. The lower diagram shows the opening position of the flap 18.

In a first scenario, the flap 18 starts to close at time t1. The flap 18 moves from a first position P1 to a second position P2. Presently, the flap 18 is fully open in the position P1 and fully closed in the second position P2.

Before closing, i.e. when the flap 18 is open, a temperature T1 of approx. 40° C. is measured at the temperature sensor 13. At this time, the temperature in the cooking chamber is approximately 210° C. Shortly after time t1, presently at time t2, the temperature sensor 13 detects a temperature increase. The temperature rises to temperature T2 and stabilizes there. The maximum of T2 can be the cooking chamber temperature of approx. 210° C. At time t4, the flap 18 is opened again and the temperature falls back to temperature T1.

A similar, second scenario begins at time t5. The damper 18 is closed, the temperature sensor 13 detects a temperature rise up to the temperature T2, the damper 18 is opened again and the temperature falls back to the temperature T1. Compared to the first scenario starting at time t1, a steeper temperature rise is detected in the second scenario starting at time t5.

In both scenarios, the controller determines the maximum slope 30, 31 of the temperature, the absolute temperature difference 40, 41 within a predetermined time period, and the time delay 50, 51 between when the damper 18 leaves position P1 until the temperature rise is detected at times t2 and t6.

It was found that the maximum slope 30, 31 of the measured temperature depends on the volume flow through the first opening 12. The volume flow through the first opening 12 is greater the more gas is released from the food into the cooking chamber. That is, the maximum slope 30, 31 of the measured temperature is a measure of the evaporation rate of the food. In other words, the maximum temperature slope determined can be used to draw conclusions about the condition of the food being cooked.

The more gas the food emits into the cooking chamber, the more humid the climate inside the cooking chamber will be at a given slider position. Thus, the humidity inside the cooking chamber is also dependent on the determined maximum temperature slope.

In the first scenario, the maximum temperature gradient 30 is lower than the maximum temperature gradient 31 in the second scenario. This means that a higher evaporation rate emanates from the food in the second scenario than in the first scenario. Knowing the temperature prevailing in the cooking chamber and the position of the flap 18, the evaporation rate can be used to infer the humidity prevailing in the cooking chamber. For the first scenario, a humidity of 26% by volume is determined in the cooking chamber. In the second scenario, a humidity of 42 vol % is determined due to the larger maximum gradient. These values can be determined using calibration measurements for different cooking chamber temperatures and different flap positions and stored in the cooking device.

The determined time intervals 50 and 51 also represent a measure of the evaporation rate of the food being cooked. The higher the volume flow, the faster the temperature sensor will detect the steam and the shorter the determined time interval. The determined time interval 50 of the first scenario is longer than the determined time interval 51 of the second scenario. This indicates that the evaporation rate within the cooking chamber is greater in the second scenario than in the first scenario. With the same cooking chamber temperature and the same slider position, it is also possible to draw the conclusion that the humidity is higher in the second scenario than in the first scenario.

The advantage of this method is that once the time intervals 50 and 51 have been determined, the measurement is already complete, the slider can be returned to its initial position, so that the measurement interval is as short as possible and the cooking process is only slightly affected by the measurement process.

Furthermore, the absolute temperature differences 40 and 41 determined can also provide an indication of the condition of the food being cooked. The temperature differences 40 and 41 are temperature changes which are determined within a certain time period since leaving the position P1. The time periods are from t1 to t3 and from t5 to t7. These two time periods are identical and predetermined. The temperature difference 41 is greater than the temperature difference 40, which allows a conclusion that the volume flow in the second scenario is greater than in the first scenario.

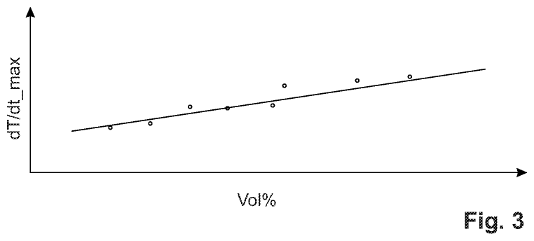

FIG. 3 schematically shows a series of measurements which examines the relationship between the humidity determined in the cooking chamber in vol % and the maximum temperature gradient determined at the temperature sensor 13. The steeper the temperature rise at the temperature sensor 13, the higher the humidity prevailing in the cooking chamber at the same cooking chamber temperature and the same position P1 of the slider. This relationship depends on the device. This can be checked by means of a calibration measurement and stored in the control system.

Now to the control of the cooking process: Conclusions on the humidity inside the cooking chamber or on the condition of the food can be used to control the cooking process. Furthermore, these measured values can be displayed to the user. The user could, for example, terminate the cooking process on the basis of the displayed measured value.

Depending on the food to be cooked, a more or less humid atmosphere is desired in the cooking chamber. If the determined humidity in the cooking chamber is too high, for example, the flap 18 can be opened more and/or the device fan is operated at a higher level. If the determined humidity in the cooking chamber is too low, for example, the flap 18 can be closed more and/or the device fan is operated at a lower level.

Furthermore, there is food, such as frozen ham croissants, which should be cooked neither in a completely dry nor in a completely humid environment. The method according to the present invention allows to determine the humidity inside the cooking chamber, in order to subsequently control the slider and the device fan in such a way that the desired humidity is present in the cooking chamber.

While preferred embodiments of the invention are described in the present application, it should be clearly noted that the invention is not limited to these and may also be carried out in other ways within the scope of the following claims.

What is claimed is:

1. A cooking method for preparing food in the cooking chamber of a cooking device, wherein
the cooking chamber has a first opening, a second opening and a closure for closing the second opening,
the cooking device has a temperature sensor arranged outside the cooking chamber for detecting gas volume flowing out of the cooking chamber through the first opening,
wherein
during the cooking method the closure is moved from a first position to a second position and after leaving the first position, in particular after reaching the second position, a measurement is performed by the temperature sensor.

2. The cooking method according to claim 1, wherein the first opening and the second opening are arranged at one or more inner walls of the cooking chamber.

3. The cooking method according to claim 1, wherein the first opening and the second opening are not openings through which the food to be cooked can be introduced into the cooking chamber, in particular wherein the closure is not the user door for opening and closing the cooking chamber.

4. The cooking method according to claim 1, wherein the closure is moved from the first position to the second position, at an arbitrary time during the cooking method, if the measurement should be performed.

5. The cooking method according to claim 1, wherein the closure is moved from a first position to a second position in closing direction during the cooking method, in particular wherein the second opening is completely closed in the second position.

6. The cooking method according to claim 1, wherein the volume flow through the first opening is determined by the measurement of the temperature sensor, in particular wherein the volume flow is determined as a function of the cooking chamber temperature.

7. The cooking method according to claim 1, wherein the volume flow of gas volumes escaping from the food is determined by the measurement of the temperature sensor.

8. The cooking method according to claim 1, wherein the slope, in particular the maximum slope, of a temperature change, in particular of a temperature rise, is determined.

9. The cooking method according to claim 1, wherein the time is measured between leaving the first position or reaching the second position until the temperature sensor detects a change, in particular a temperature rise, in particular a temperature rise from a predetermined value.

10. The cooking method according to claim 1, wherein an absolute temperature change during a predetermined time period after leaving the first position is determined by the measurement of the temperature sensor.

11. The cooking method according to claim 1, wherein the humidity inside the cooking chamber is determined by the measurement of the temperature sensor.

12. The cooking method according to claim 11, wherein the cooking chamber temperature and the first position are taken into account to determine the humidity.

13. The cooking method according to claim 1, wherein in dependence on the measurement by the temperature sensor,
a new target position of the closure is determined, and/or
a steam generator is operated.

14. The cooking method according to claim 1, wherein in dependence on the measurement by the temperature sensor, process parameters of the cooking method are changed, in particular wherein
the cooking process is ended, and/or
the cooking chamber temperature is adjusted, and/or
the operating power of a device fan is set, and/or
a new program phase is initiated.

15. The cooking method according to claim 1, wherein no water vapor is supplied to the cooking chamber from outside the cooking chamber during the cooking method.

16. The cooking method according to claim 1, wherein the measurement by the temperature sensor is carried out within a predetermined period of time since leaving the first position, in particular within 10 minutes, in particular within 5 minutes, in particular within 2 minutes, in particular within 1 minute.

17. A method for measuring a parameter, in particular a cooking chamber parameter or food parameter during a cooking process according to claim 1.
